(19) United States
(12) Patent Application Publication
(10) Pub. No.: US 2023/0238538 A1
(43) Pub. Date: Jul. 27, 2023

(54) CATHODE FOR ALL-SOLID-STATE BATTERY COMPRISING CONDUCTIVE MATERIAL COMPOSITE AND METHOD OF MANUFACTURING THE SAME

(71) Applicants: HYUNDAI MOTOR COMPANY, Seoul (KR); KIA CORPORATION, Seoul (KR)

(72) Inventors: Seung Ho Choi, Hanam-si (KR); Yun Sung Kim, Seoul (KR); Kyu Joon Lee, Seoul (KR); Sang Heon Lee, Yongin-si (KR); Ga Hyeon Im, Hwaseong-si (KR)

(73) Assignees: HYUNDAI MOTOR COMPANY, Seoul (KR); KIA CORPORATION, Seoul (KR)

(21) Appl. No.: 18/079,461

(22) Filed: Dec. 12, 2022

(30) Foreign Application Priority Data
Jan. 25, 2022 (KR) 10-2022-0010363

(51) Int. Cl. H01M 4/62; H01M 10/0562

(52) U.S. Cl. CPC H01M 4/625; H01M 10/0562; H01M 2004/028

(57) ABSTRACT

A cathode for an all-solid-state battery includes a conductive material wherein the conductive material includes a carbon-based material and a metal fluoride disposed on the surface of the carbon-based material, and a method of manufacturing the same. The cathode for an all-solid-state battery includes a cathode active material, a solid electrolyte, and a conductive material, wherein the conductive material includes a carbon-based material and a metal fluoride disposed on a surface of the carbon-based material.

### CROSS-REFERENCE TO RELATED APPLICATION

This application claims under 35 U.S.C. §119(a) the benefit of priority to Korean Patent Application No. 10-2022-0010363, filed on Jan. 25, 2022 in the Korean Intellectual Property Office, the entire contents of which are incorporated herein by reference.

### TECHNICAL FIELD

The present disclosure relates to a cathode for an all-solid-state battery including a conductive material wherein the conductive material includes a carbon-based material and a metal fluoride disposed on the surface of the carbon-based material, and a method of manufacturing the same.

### BACKGROUND

An all-solid-state battery is a next-generation secondary battery that uses a solid electrolyte without the risk of fire for the conduction of lithium ions.

Solid electrolytes conducts lithium ions between a cathode and an anode based on the high lithium ion conductivity thereof.

Typically, sulfide-based solid electrolytes advantageously exhibit high lithium ion conductivity and can form uniform interface with other components merely through pressurization. However, sulfide-based solid electrolytes are highly reactive, so electrochemical decomposition occurs or the crystal structure thereof easily changes. For stable operation of the battery, it is desirable to maintain the structure and characteristics of solid electrolytes with as little change as possible during charging and discharging.

A cathode of an all-solid-state battery includes a cathode active material, a sulfide-based solid electrolyte, and a carbon-based conductive material. During charging and discharging, lithium ions move along the solid electrolyte, while electrons move through the conductive material. As electrons moving through the conductive material move to the solid electrolyte and come into physical contact therewith, an oxidation reaction occurs at the interface, leading to electrochemical decomposition of the solid electrolyte. Such decomposition lowers the lithium ion conductivity of the solid electrolyte, which directly relates to deterioration of the battery properties. Therefore, when the movement of electrons from the conductive material to the solid electrolyte is suppressed by minimizing physical contact between the solid electrolyte and the conductive material, the characteristics of the battery can be greatly improved.

The above information disclosed in this Background section is only for enhancement of understanding of the background of the disclosure, and therefore it may contain information that does not form the prior art that is already known in this country to a person of ordinary skill in the art.

### SUMMARY

The present disclosure has been made in an effort to solve the above-described problems associated with the prior art, and it is one object of the present disclosure to provide a cathode for an all-solid-state battery that minimizes physical contact between a solid electrolyte and a conductive material, and a method of manufacturing the same.

The objects of the present disclosure are not limited to that described above. Other objects of the present disclosure will be clearly understood from the following description, and are able to be implemented by means defined in the claims and combinations thereof.

In one aspect, the present disclosure provides a cathode for an all-solid-state battery including a cathode active material, a solid electrolyte, and a conductive material, wherein the conductive material includes a carbon-based material and a metal fluoride disposed on the surface of the carbon-based material.

The carbon-based material may include a nonlinear material.

The nonlinear material comprises at least one selected from the group consisting of carbon black, acetylene black, Ketjen black, channel black, furnace black, and combinations thereof.

The carbon-based material may include a linear material.

The linear material comprises at least one selected from the group consisting of carbon fibers, carbon nanotubes, vapor-grown carbon fibers, and combinations thereof.

The carbon-based material may include a linear material having a diameter of about 100 nm to 300 nm and a length of about 2 µm to 10 µm.

The metal fluoride may be disposed as a powder on the surface of the carbon-based material.

The metal fluoride may include a compound represented by the following Formula 1:

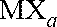

wherein M includes an alkali metal, X includes a halogen element, and a satisfies 1≤a≤2.

The metal fluoride may include at least one selected from the group consisting of MgF₂, CaF₂, LiF, NaF, BaF₂, and combinations thereof.

The metal fluoride may have an average particle diameter (D50) of 10 nm to 1,000 nm.

The metal fluoride may include primary particles or consist of primary particles.

The conductive material may include an amount of about 50% to 90% by weight of the carbon-based material and an amount of about 10% to 50% by weight of the metal fluoride.

Any one part of the surface of the carbon-based material may be in contact with the cathode active material, and another part of the surface of the carbon-based material, which the metal fluoride is disposed, may not be in contact with the solid electrolyte due to the metal fluoride.

In another aspect, the present disclosure provides a method of manufacturing a cathode for an all-solid-state battery including preparing a conductive material including a carbon-based material and a metal fluoride disposed on the surface of the carbon-based material, and forming a cathode including the conductive material, a cathode active material, and a solid electrolyte.

The conductive material may be prepared by mixing the carbon-based material with the metal fluoride by mechanical milling.

The conductive material may be prepared by spray-coating the metal fluoride on the carbon-based material.

Other aspects and preferred embodiments of the disclosure are discussed infra.

### BRIEF DESCRIPTION OF THE DRAWINGS

The above and other features of the present disclosure will now be described in detail with reference to certain exemplary embodiments thereof, illustrated in the accompanying drawings which are given hereinbelow by way of illustration only, and thus are not limitative of the present disclosure, and wherein:

FIG. 1 illustrates an all-solid-state battery according to the present disclosure;

FIG. 2 illustrates the components of a cathode according to the present disclosure;

FIG. 3 shows the result of scanning electron microscopy (SEM) of a carbon-based material of Example 1;

FIG. 4 shows the result of scanning electron microscopy (SEM) of a metal fluoride of Example 1;

FIG. 5 shows the result of scanning electron microscopy/energy-dispersive X-ray spectroscopy (SEM-EDS) of the conductive material of Example 1;

FIG. 6 shows the result of scanning electron microscopy/energy dispersive X-ray spectrometry (SEM-EDS) of the cathode of Example 1;

FIG. 7 shows the result of measurement of the initial cycle characteristics of the half cells according to Examples 1 and 2 and Comparative Example;

FIG. 8 shows the result of measurement of the cycle characteristics of the half cells according to Examples 1 and 2 and Comparative Example; and

FIG. 9 shows the result of measurement of the efficiency per cycle of the half cells according to Examples 1 and 2 and Comparative Example.

### DETAILED DESCRIPTION

The objects described above, as well as other objects, features and advantages, will be clearly understood from the following preferred embodiments with reference to the attached drawings. However, the present disclosure is not limited to the embodiments, and may be embodied in different forms. The embodiments are suggested only to offer a thorough and complete understanding of the disclosed context and to sufficiently inform those skilled in the art of the technical concept of the present disclosure.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present disclosure, a “first” element may be referred to as a “second” element, and similarly, a “second” element may be referred to as a “first” element. Singular forms are intended to include plural forms as well, unless the context clearly indicates otherwise.

It will be further understood that terms such as “comprise” or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all such numbers, figures and/or expressions. As used herein, the term “about” means modifying, for example, lengths, degrees of errors, dimensions, the quantity of an ingredient in a composition, concentrations, volumes, process temperature, process time, yields, flow rates, pressures, and like values, and ranges thereof, refers to variation in the numerical quantity that may occur, for example, through typical measuring and handling procedures used for making compounds, compositions, concentrates or use formulations; through inadvertent error in these procedures; through differences in the manufacture, source, or purity of starting materials or ingredients used to carry out the methods; and like considerations. Whether modified by the term “about” the claims appended hereto include equivalents to these quantities. The term “about” further may refer to a range of values that are similar to the stated reference value. In certain embodiments, the term “about” refers to a range of values that fall within 10, 9, 8,7, 6, 5,4, 3, 2, 1 percent above or below the numerical value (except where such number would exceed 100% of a possible value or go below 0%) or a plus/minus manufacturing/measurement tolerance of the numerical value. In addition, when numerical ranges are disclosed in the description, these ranges are continuous, and include all numbers from the minimum to the maximum, including the maximum within each range, unless otherwise defined. Furthermore, when the range refers to an integer, it includes all integers from the minimum to the maximum, including the maximum within the range, unless otherwise defined.

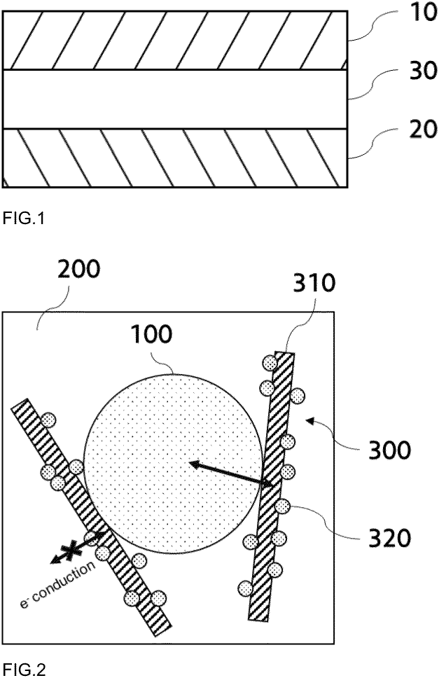

FIG. 1 illustrates an all-solid-state battery according to the present disclosure. The all-solid-state battery includes a cathode 10, an anode 20, and a solid electrolyte layer 30 interposed between the cathode 10 and the anode 20.

FIG. 2 schematically shows the components of the cathode 10 according to the present disclosure. Referring to this, the cathode 10 may include a cathode active material 100, a solid electrolyte 200, and a conductive material 300.

The cathode active material 100 may occlude and release lithium ions. The cathode active material is not particularly limited, but may include, for example, an oxide active material or a sulfide active material.

The oxide active material may include a rock-salt-layer-type active material such as LiCoO₂, LiMnO₂, LiNiO₂, LiVO₂, or Li₁₊ₓNi_{⅓}Co_{⅓}Mn_{⅓}O₂, a spinel-type active material such as LiMn₂O₄ or Li(Ni_{0.5}Mn_{1.5})O₄, a reverse-spinel-type active material such as LiNiVO₄ or LiCoVO₄, an olivine-type active material such as LiFePO₄, LiMnPO₄, LiCoPO₄, or LiNiPO₄, a silicon-containing active material such as Li₂FeSiO₄ or Li₂MnSiO₄, a rock-salt-layer-type active material having a transition metal, a portion of which is substituted with a heterogeneous metal such as LiNi_{0.8}Co_{(0.2-x)}AlₓO₂ (0 < x < 0.2), a spinel-type active material having a transition metal, a portion of which is substituted with a heterogeneous metal such as Li₁₊ₓMn_{2-x-y}M_{y}O₄ (wherein M includes at least one of Al, Mg, Co, Fe, Ni, Zn, and 0<x+y<2), and a lithium titanate such as Li₄Ti₅O₁₂.

The sulfide active material may include copper sulfide, iron sulfide, cobalt sulfide, nickel sulfide, or the like.

The solid electrolyte 200 may conduct lithium ions in the cathode 10. The solid electrolyte 200 may include an oxide-based solid electrolyte or a sulfide-based solid electrolyte. However, it is preferable to use a sulfide-based solid electrolyte having high lithium ion conductivity.

The sulfide solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers and Z is one of Ge, Zn, and Ga), Li₂S—GeS₂, Li₂S—SiS₂—Li₃PO₄, Li₂S—SiS₂—LiₓMO_{y} (wherein x and y are positive numbers and M is one of P, Si, Ge, B, Al, Ga, and In), Li₁₀GeP₂S₁₂, or the like.

The conductive material 300 may include a carbon-based material 310 and a metal fluoride 320 disposed on the surface of the carbon-based material 310.

The cathode active material 100 physically contacts the solid electrolyte 200 and the conductive material 300 in the cathode 10. Accordingly, during charging and discharging of the all-solid-state battery, lithium ions may move between the cathode active material 100 and the solid electrolyte 200, and electrons may move between the cathode active material 100 and the conductive material 300. The solid electrolyte 200 also physically contacts the conductive material 300. The movement of electrons between the solid electrolyte 200 and the conductive material 300 causes electrochemical decomposition of the solid electrolyte 22, thus resulting in problems such as increased electrode resistance and reduced lithium ion conductivity.

Accordingly, in the present disclosure, the metal fluoride 320, having excellent insulating property and chemical resistance, is attached to the surface of the carbon-based material 310 to minimize the contact area between the carbon-based material 310 and the solid electrolyte 200. Specifically, one part of the surface of the carbon-based material 310 is in contact with the cathode active material 100 to allow electrons to move between the two components, and at the same time, another part of the surface of the carbon-based material 310 is covered with the metal fluoride 320 and is not in contact with the solid electrolyte 200, thereby suppressing side reactions. The metal fluoride may cover about 50% or more, 60% or more, 70% or more, 80% or more, 90% or more, or entire area of the another part.

The carbon-based material 310 may include a nonlinear material and/or a linear material.

The nonlinear material may include at least one selected from the group consisting of carbon black, acetylene black, Ketjen black, channel black, furnace black, and combinations thereof.

The linear material may include at least one selected from the group consisting of carbon fibers, carbon nanotubes, vapor-grown carbon fibers (VGCF), and combinations thereof.

In view of the electron conductivity of the cathode 10, the carbon-based material 310 preferably includes a linear material. Specifically, the carbon-based material 310 may include a linear material having a diameter of about 100 nm to 300 nm and a length of about 2 µm to 10 µm.

The metal fluoride 320 may be attached as a powder to the surface of the carbon-based material 310. Attachment or location of the metal fluoride 320 as a powder means that the metal fluoride 320 is in contact with the surface of the material 310 while maintaining a particle shape, rather than forming a layer that completely covers the surface of the carbon-based material 310. When the metal fluoride 320 covers the surface of the carbon-based material 310 in the form of a coating layer, the carbon-based material 310 cannot be in contact with the cathode active material 100. Therefore, the conductive material 300 according to the present disclosure is distinguished from a core-sheath configuration.

The metal fluoride 320 may be non-agglomerated primary particles. If the metal fluoride 320 is aggregated secondary particles, it may not form a uniform composite with the carbon-based material 310. The proportion of the primary particles may be 50% or more, 60% or more, 70% or more, 80% or more, 90% or more, or all of the metal fluoride.

The metal fluoride 320 may include a compound represented by the following Formula 1:

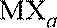

wherein M includes an alkali metal, X includes a halogen element, and a satisfies 1≤a≤2.

The metal fluoride 320 may include at least one selected from the group consisting of MgF₂, CaF₂, LiF, NaF, BaF₂, and combinations thereof.

The metal fluoride 320 is chemically very stable and does not react even if it comes into contact with the solid electrolyte 200, and has insulating property, thus being suitable for minimizing the contact area between the carbon-based material 310 and the solid electrolyte 200.

The metal fluoride 320 may have an average particle diameter (D50) of about 10 nm to 1,000 nm.

The conductive material 300 may include an amount of about 50% to 90% by weight of the carbon-based material and an amount of about 10% to 50% by weight of the metal fluoride. When the content of the metal fluoride 320 exceeds 50% by weight, the electron conductivity in the cathode 10 may be excessively low, and when the content is less than 10% by weight, the effect of minimizing the contact area between the carbon-based material 310 and the solid electrolyte 200 may be insufficient.

According to a first embodiment of the present disclosure, the anode 20 may be a composite anode including an anode active material and a solid electrolyte.

The anode active material is not particularly limited, but may be, for example, a carbon active material or a metal active material.

The carbon active material may include graphite such as mesocarbon microbeads (MCMB), highly oriented pyrolytic graphite (HOPG), and amorphous carbon such as hard carbon and soft carbon.

The metal active material may include In, Al, Si, Sn, an alloy containing at least one of these elements or the like.

The solid electrolyte conducts lithium ions in the anode 20. The solid electrolyte may include an oxide-based solid electrolyte or a sulfide-based solid electrolyte. However, it is preferable to use a sulfide-based solid electrolyte having high lithium ion conductivity.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers and Z is one of Ge, Zn, and Ga), Li₂S—GeS₂, Li₂S—SiS₂—Li₃PO₄, Li₂S—SiS₂—LiₓMO_{y} (wherein x and y are positive numbers and M is one of P, Si, Ge, B, Al, Ga, and In), Li₁₀GeP₂S₁₂, or the like.

According to a second embodiment of the present disclosure, the anode 20 may include a lithium metal or a lithium metal alloy.

The lithium metal alloy may include an alloy of lithium and a metal or metalloid capable of being alloyed with lithium. The metal or metalloid capable of being alloyed with lithium may include Si, Sn, Al, Ge, Pb, Bi, Sb, or the like.

According to a third embodiment of the present disclosure, the anode 20 may not include an anode active material and a component substantially performing the same function. When an all-solid-state battery is charged, lithium ions moved from the cathode 10 are deposited and stored in the form of lithium metal between the anode 20 and an anode current collector (not shown).

The anode 20 may include amorphous carbon and a metal capable of forming an alloy with lithium.

The amorphous carbon may include at least one selected from the group consisting of furnace black, acetylene black, Ketjen black, graphene, and combinations thereof.

The metal may include at least one selected from the group consisting of gold (Au), platinum (Pt), palladium (Pd), silicon (Si), silver (Ag), aluminum (Al), bismuth (Bi), tin (Sn), zinc (Zn) and combinations thereof.

The solid electrolyte layer 30 conducts lithium ions between the cathode 10 and the anode 20.

The solid electrolyte layer 30 may include a solid electrolyte. The solid electrolyte may include an oxide-based solid electrolyte or a sulfide-based solid electrolyte. However, it is preferable to use a sulfide-based solid electrolyte having high lithium ion conductivity.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers and Z is one of Ge, Zn, and Ga), Li₂S—GeS₂, Li₂S—SiS₂—Li₃PO₄, Li₂S—SiS₂—LiₓMO_{y} (wherein x and y are positive numbers and M is one of P, Si, Ge, B, Al, Ga, and In), Li₁₀GeP₂S₁₂, or the like.

The method of manufacturing a cathode for an all-solid-state battery according to the present disclosure includes preparing a conductive material 300 including a carbon-based material 310 and a metal fluoride 320 disposed on a surface of the carbon-based material 310 and forming a cathode 10 including the conductive material 300, the cathode active material 100, and the solid electrolyte 200.

The conductive material 300 may be prepared by mixing the carbon-based material 310 with the metal fluoride 320 using mechanical milling. The specific method of mechanical milling is not particularly limited, and the mechanical milling may be selected from ball milling, air jet milling, bead milling, roll-milling, planetary milling, hand milling, high-energy ball milling, stirred ball milling, vibrating milling, mechanofusion milling, shaker milling, attritor milling, disk milling, shape milling, nauta milling, nobilta milling, high-speed mixing, or the like.

Meanwhile, the conductive material 300 may be prepared by spray-coating a metal fluoride 320 on the carbon-based material 310. Specifically, the conductive material 300 may be prepared by spraying the metal fluoride 320 in a powder form on the carbon-based material 310.

The method of manufacturing the cathode 10 is not particularly limited, and the cathode 10 may be manufactured by a dry method or a wet method. For example, the conductive material 300 is added to a solvent along with the cathode active material 100 and the solid electrolyte 200 to obtain a slurry, and the slurry is applied onto a substrate and dried to prepare the cathode 10. Meanwhile, the cathode 10 may be formed by pressing the powder including the cathode active material 100, the solid electrolyte 200, and the conductive material 300 at a high pressure.

Hereinafter, the present disclosure will be described in more detail with reference to specific examples. However, the following examples are provided only for better understanding of the present disclosure, and thus should not be construed as limiting the scope of the present disclosure.

### Example 1

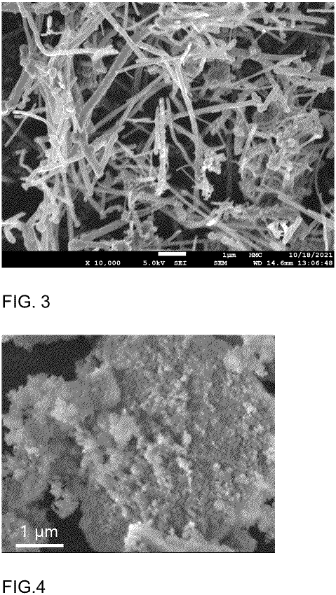

A linear vapor-grown carbon fiber (VGCF) was used as the carbon-based material. FIG. 3 shows the result of scanning electron microscopy (SEM) of the carbon-based material.

MgF₂ was used as the metal fluoride. FIG. 4 shows the result of scanning electron microscopy (SEM) of the metal fluoride. It can be seen from FIG. 4 that the metal fluoride is in the form of non-agglomerated primary particles and has an average particle diameter (D50) of several tens of nm.

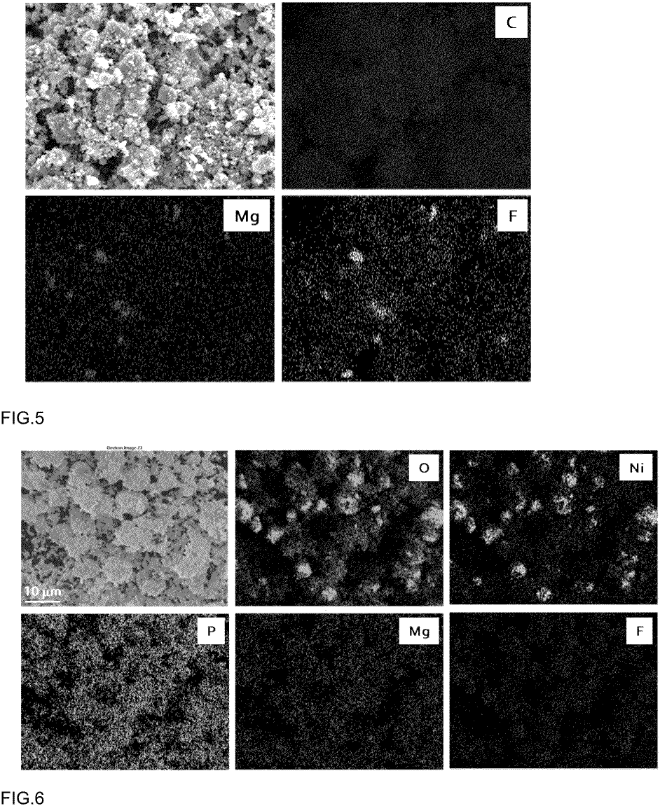

A conductive material was prepared by mixing 90% by weight of the carbon-based material with 10% by weight of metal fluoride by mechanical milling. FIG. 5 shows the result of scanning electron microscopy/energy-dispersive X-ray spectroscopy (SEM-EDS) of the conductive material. As can be seen from FIG. 5, it is difficult to determine the linear shape of the carbon-based material, because the metal fluoride is uniformly distributed as a powder on the surface of the carbon-based material. In addition, it can be seen that magnesium (Mg) and fluorine (F) are uniformly distributed along with carbon (C). This shows that the carbon-based material and the metal fluoride are capable of forming a composite through mechanical milling.

A half-cell including the conductive material was prepared as follows.

200 mg of a sulfide-based solid electrolyte was pressed at a pressure of about 100 MPa in a mold having a diameter of 13φ for about 1 minute to form a solid electrolyte layer.

A powder containing 65% by weight of LiNiCoMnO₂ (701515) as a cathode active material, 30% by weight of a sulfide-based solid electrolyte, and 5% by weight of the conductive material was prepared, 50 mg of the powder was applied to one surface of the solid electrolyte layer, and pressure was applied thereto at about 450 MPa for about 1 minute to prepare a cathode.

A lithium metal was pressed on the other surface of the solid electrolyte layer at a pressure of about 30 MPa to prepare a half-battery.

FIG. 6 shows the result of scanning electron microscopy/energy dispersive X-ray spectrometry (SEM-EDS) of the cathode. The positions of nickel (Ni) and oxygen (O) are the same as the positions of magnesium (Mg) and fluorine (F), which indicates that the conductive material is disposed around the cathode active material.

### Example 2

A half-cell was prepared in the same manner as in Example 1, except that a conductive material was prepared using 50% by weight of a carbon-based material and 50% by weight of a metal fluoride.

### Comparative Example

A half-cell was prepared in the same manner as in Example 1, except that a conductive material was prepared using 100% by weight of a carbon-based material without metal fluoride.

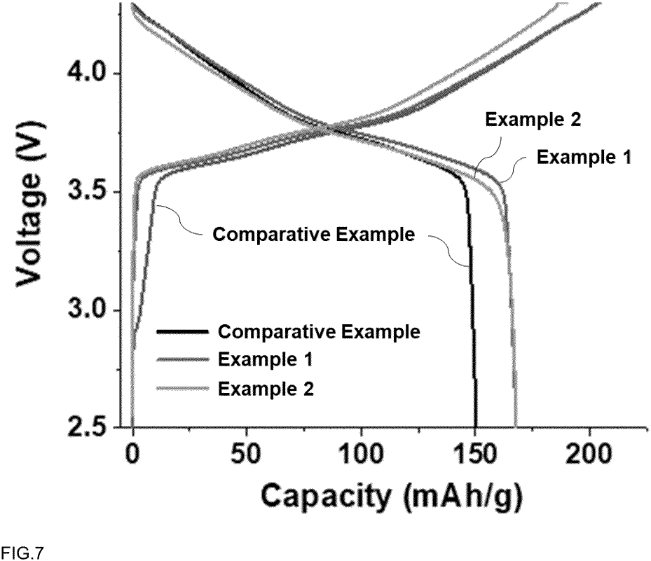

FIG. 7 shows the result of measurement of the initial cycle characteristics of the half cells according to Examples 1 and 2 and Comparative Example. Evaluation conditions include a current density of 0.3 C, an evaluation voltage of 2.5 V to 4.3 V, and an evaluation temperature of 60° C. It can be seen from FIG. 7 that, in Comparative Example, a capacity of about 15 mAh/g was observed from 0 V to about 3.6 V during the charging process, which means that a reaction occurs between the sulfide-based solid electrolyte and the conductive material. That is, this means that, in the cathode, electrons move from the conductive material to the sulfide-based solid electrolyte, so the sulfide-based solid electrolyte is oxidized. In contrast, in Examples 1 and 2, a capacity was not observed at up to 3.6 V, which means that the metal fluoride can effectively inhibit oxidation of the sulfide-based solid electrolyte.

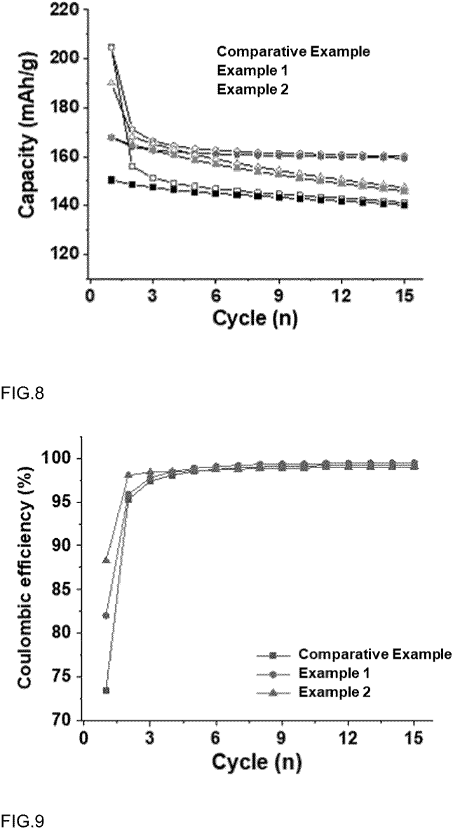

FIG. 8 shows the result of measuring the cycle characteristics of the half cells according to Examples 1 and 2 and Comparative Example. It can be seen from FIG. 8 that the reversible capacity of the half-cells according to Examples 1 and 2 is higher than that of the half-cell according to Comparative Example. In addition, the reversible capacity of the half-cell according to Example 1 does not decrease and is maintained for 15 cycles. Meanwhile, the reversible capacity of the half-cell according to Example 2 decreases, which is considered to be due to the fact that the metal fluoride somewhat lowers the electrical conductivity in the cathode. However, Example 2 exhibits a slightly low reversible capacity, whereas Comparative Example exhibits a high reversible capacity and very high initial efficiency, as will be described later. Meanwhile, it can be seen that, if the metal fluoride is present in an excessively high amount, the reversible capacity may be lowered, so an appropriate amount should be used.

FIG. 9 shows the result of measurement of the efficiency per cycle of the half cells according to Examples 1 and 2 and Comparative Example. It can be seen from FIG. 9 that the half-cells according to Examples 1 and 2 have significantly superior initial efficiency compared to the half-cell of Comparative Example.

As is apparent from the foregoing, according to the present disclosure, it is possible to obtain a cathode for an all-solid-state battery that minimizes physical contact between a solid electrolyte and a conductive material, and a method for manufacturing the same.

According to the present disclosure, it is possible to obtain a cathode for an all-solid-state battery having excellent cycle characteristics and enabling fast charging and discharging.

The effects of the present disclosure are not limited to those mentioned above. It should be understood that the effects of the present disclosure include all effects that can be inferred from the description of the present disclosure.

The present disclosure has been described in detail with reference to embodiments thereof. However, it will be appreciated by those skilled in the art that changes may be made in these embodiments without departing from the principles and spirit of the present disclosure, the scope of which is defined in the appended claims and their equivalents.

What is claimed is:

1. A cathode for an all-solid-state battery comprising:
a cathode active material;
a solid electrolyte; and
a conductive material,
wherein the conductive material comprises a carbon-based material and a metal fluoride disposed on a surface of the carbon-based material.

2. The cathode for an all-solid-state battery according to claim 1, wherein the carbon-based material comprises a nonlinear material, and
the nonlinear material comprises at least one of carbon black, acetylene black, Ketjen black, channel black, furnace black or any combination thereof.

3. The cathode for an all-solid-state battery according to claim 1, wherein the carbon-based material comprises a linear material, and
the linear material comprises at least one of carbon fibers, carbon nanotubes, vapor-grown carbon fibers or any combination thereof.

4. The cathode for an all-solid-state battery according to claim 1, wherein the carbon-based material comprises a linear material having a diameter of about 100 nm to 300 nm and a length of about 2 µm to 10 µm.

5. The cathode for an all-solid-state battery according to claim 1, wherein the metal fluoride is disposed as a powder on the surface of the carbon-based material.

6. The cathode for an all-solid-state battery according to claim 1, wherein the metal fluoride comprises a compound represented by the following Formula 1: 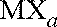
wherein M comprises an alkali metal;
X comprises a halogen element; and
a satisfies 1 ≤a≤2.

7. The cathode for an all-solid-state battery according to claim 1, wherein the metal fluoride comprises at least one of MgF₂, CaF₂, LiF, NaF, BaF₂ or any combination thereof.

8. The cathode for an all-solid-state battery according to claim 1, wherein the metal fluoride has an average particle diameter (D50) of about 10 nm to 1,000 nm.

9. The cathode for an all-solid-state battery according to claim 1, wherein the metal fluoride comprises primary particles.

10. The cathode for an all-solid-state battery according to claim 1, wherein the conductive material comprises an amount of about 50% to 90% by weight of the carbon-based material and an amount of about 10% to 50% by weight of the metal fluoride.

11. The cathode for an all-solid-state battery according to claim 1, wherein one part of the surface of the carbon-based material is in contact with the cathode active material, and
another part of the surface of the carbon-based material is not in contact with the solid electrolyte by the metal fluoride.

12. A method of manufacturing a cathode for an all-solid-state battery comprising:
preparing a conductive material comprising a carbon-based material and a metal fluoride disposed on a surface of the carbon-based material; and
forming a cathode including the conductive material, a cathode active material, and a solid electrolyte.

13. The method according to claim 12, wherein the carbon-based material comprises at least one of a nonlinear material, a linear material or any combination thereof,
the nonlinear material comprises at least one of carbon black, acetylene black, Ketjen black, channel black, furnace black or any combination thereof, and
the linear material comprises at least one of carbon fibers, carbon nanotubes, vapor-grown carbon fibers or any combination thereof.

14. The method according to claim 12, wherein the carbon-based material comprises a linear material having a diameter of about 100 nm to 300 nm and a length of about 2 µm to 10 µm.

15. The method according to claim 12, wherein the conductive material is prepared by mixing the carbon-based material with the metal fluoride using mechanical milling.

16. The method according to claim 12, wherein the conductive material is prepared by spray-coating the metal fluoride on the carbon-based material.

17. The method according to claim 12, wherein the metal fluoride is disposed as a powder on the surface of the carbon-based material.

18. The method according to claim 12, wherein the metal fluoride comprises a compound represented by the following Formula 1: 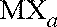
wherein M comprises an alkali metal;
X comprises a halogen element; and
a satisfies 1 ≤a≤2.

19. The method according to claim 12, wherein the metal fluoride comprises at least one of MgF₂, CaF₂, LiF, NaF, BaF₂ or any combination thereof.

20. The method according to claim 12, wherein the conductive material comprises an amount of about 50% to 90% by weight of the carbon-based material and an amount of about 10% to 50% by weight of the metal fluoride.
